(19) United States
(12) Patent Application Publication
(10) Pub. No.: US 2025/0236800 A1
(43) Pub. Date: Jul. 24, 2025

(54) COUPLING SYSTEM OF BIOMASS GASIFICATION AND WASTE INCINERATION

(71) Applicant: HUADIAN ELECTRIC POWER RESEARCH INSTITUTE CO., LTD., Hangzhou, Zhejiang (CN)

(72) Inventors: Zhipeng XUE, Hangzhou, Zhejiang (CN); Junfeng XU, Hangzhou, Zhejiang (CN); Sheng HE, Hangzhou, Zhejiang (CN)

(73) Assignee: HUADIAN ELECTRIC POWER RESEARCH INSTITUTE CO., LTD., Hangzhou, Zhejiang (CN)

(21) Appl. No.: 18/699,902

(22) PCT Filed: Sep. 21, 2023
(86) PCT No.: PCT/CN2023/120256

§ 371 Date: Apr. 11, 2024

(30) Foreign Application Priority Data
Aug. 8, 2023 (CN) 202310991422.9

(51) Int. Cl. C10J 3/56; C10J 3/72; F23G 5/00; F23G 5/46

(52) U.S. Cl. CPC C10J 3/56; C10J 3/723; F23G 5/006; F23G 5/46; C10J 2300/0916; C10J 2300/1253; C10J 2300/1637; C10J 2300/1807

(57) ABSTRACT

Disclosed is a coupling system of biomass gasification and waste incineration. A carbon pipeline is communicated between a biomass carbon outlet of a circulating fluidized bed gasifier and an activated carbon injection port of a waste incineration assembly. The activated carbon generated by reaction in the circulating fluidized bed gasifier is sent to the activated carbon injection port through the carbon pipeline to capture harmful substances containing heavy metals and dioxins in flue gas generated by the waste incineration assembly. According to the present application, the activated carbon generated by the circulating fluidized bed gasifier is supplied to the waste incineration assembly, and a mutual coupling between the circulating fluidized bed gasifier and the waste incineration assembly is thereby realized, thus reducing the amount of the activated carbon additionally supplied to the wasted incineration assembly.

This application claims priority to the Chinese Patent Application No. 202310991422.9, titled “COUPLING SYSTEM OF BIOMASS GASIFICATION AND WASTE INCINERATION”, filed on Aug. 8, 2023 with the China National Intellectual Property Administration, which is incorporated herein by reference in its entirety.

### FIELD

The present application relates to the technical field of waste incineration, and in particular to a coupling system of biomass gasification and waste incineration.

### BACKGROUND

A conventional method for waste disposal mainly includes landfill and incineration. Incineration of industrial waste refers to burning the industrial waste at high temperature, and converting the waste into solid refuse and flue gas. Incineration of industrial waste is a commonly used method for the waste disposal in modern industrial society, which is mainly used to solve a problem of increasing industrial waste and emission. In modern industrialization, a large number of solid, liquid and gas refuse are generated in production process. Landfilling takes up a large amount of land resources, and it can hardly dispose the waste with no remaining and can easily cause pollution. Incineration can convert waste into solid refuse and flue gas, which mitigates the problem of waste of land resources. However, incineration also has a problem of flue gas pollution. During incineration, a large number of harmful gases and solid refuse will be generated. The harmful gases include dioxins, heavy metals, nitrogen oxides and sulfides, which will do great harm to environment and human health. The solid refuse includes ash and slag, which will also pollute the environment.

In order to solve the problem of environmental protection in the incineration of industrial waste, a main method adopted at present is to capture harmful components by spraying activated carbon to purify the flue gas. Mainly by spraying activated carbon particles into the flue gas, organic substances and gaseous pollutants in the flue gas are adsorbed onto surfaces of activated carbon particles through adsorption and desorption, so as to achieve a purification effect. This purification method can effectively reduce emission of harmful substances such as dioxins and heavy metals, and protect the environment and human health. However, the injection of activated carbon has a large demand for the activated carbon, which increases the operating cost.

### SUMMARY

A coupling system of biomass gasification and waste incineration is provided according to the present application, which can reduce the amount of activated carbon additionally supplied to a waste incineration assembly, and for which it is unnecessary to separately collect and store the activated carbon generated by a circulating fluidized bed gasifier. The specific solutions are as follows.

A coupling system of biomass gasification and waste incineration includes a circulating fluidized bed gasifier and a waste incineration assembly;
where a carbon pipeline is communicated between a biomass carbon outlet of the circulating fluidized bed gasifier and an activated carbon injection port of the waste incineration assembly; and
where the activated carbon generated by reaction in the circulating fluidized bed gasifier is sent to the activated carbon injection port through the carbon pipeline to capture harmful substances containing heavy metals and dioxins in flue gas generated by the waste incineration assembly.

In an embodiment, a steam pipeline is communicated between a steam outlet of the waste incineration assembly and a steam inlet of the circulating fluidized bed gasifier; and
the steam generated by the reaction in the waste incineration assembly enters the steam inlet through the steam pipeline, so that biomass materials and the steam undergo gasification reaction in the circulating fluidized bed gasifier.

In an embodiment, a flue gas pipeline is communicated between a flue gas outlet of the waste incineration assembly and a flue gas inlet of the circulating fluidized bed gasifier; and
the flue gas generated by the reaction in the waste incineration assembly enters the flue gas inlet through the flue gas pipeline, so as to provide the heat required by the gasification reaction by means of the high-temperature flue gas.

In an embodiment, the carbon pipeline and the flue gas pipeline are respectively provided with pneumatic conveying devices.

In an embodiment, temperature of the circulating fluidized bed gasifier is controlled to be between 500° C. and 800° C.

In an embodiment, an explosion-proof isolation device is arranged between the circulating fluidized bed gasifier and the waste incineration assembly.

In an embodiment, a leakage detector is arranged near a biomass gas outlet of the circulating fluidized bed gasifier.

In an embodiment, biomass materials used in the circulating fluidized bed gasifier include rice husks, straws and forestry waste.

A coupling system of biomass gasification and waste incineration is provided according to the present application, where a carbon pipeline is communicated between a biomass carbon outlet of a circulating fluidized bed gasifier and an activated carbon injection port of a waste incineration assembly. The activated carbon generated by reaction in the circulating fluidized bed gasifier is sent to the activated carbon injection port through the carbon pipeline to capture harmful substances containing heavy metals and dioxins in flue gas generated by the waste incineration assembly. According to the present application, the activated carbon generated by the circulating fluidized bed gasifier is supplied to the waste incineration assembly, and a mutual coupling between the circulating fluidized bed gasifier and the waste incineration assembly is thereby realized, thus reducing the amount of the activated carbon additionally supplied to the wasted incineration assembly. Further, it is unnecessary to separately collect and store the activated carbon generated by the circulating fluidized bed gasifier, which can effectively reduce the operating cost.

### BRIEF DESCRIPTION OF THE DRAWINGS

For more clearly illustrating the technical solutions in the embodiments of the present application or in the conventional technology, drawings referred to for describing the embodiments or the conventional technology will be briefly described hereinafter. Apparently, the drawings in the following description are only several examples of the present application, and for those skilled in the art, other drawings may be obtained based on these drawings without any creative efforts.

FIG. 1 is a schematic view showing a specific embodiment of a coupling system of biomass gasification and waste incineration provided according to the present application.

Reference numerals in the drawings are listed as follows:
1 circulating fluidized bed gasifier, 11 biomass inlet, 12 steam inlet, 13 flue gas inlet, 14 biomass carbon outlet, 15 biomass gas outlet, 2 waste incineration assembly, 201 waste incinerator, 202 activated carbon reaction tower, 203 flue gas dust remover, 21 activated carbon injection port, 22 steam outlet, 23 flue gas outlet, 24 waste feeding port, 3 carbon pipeline, 4 steam pipeline, 5 flue gas pipeline.

### DETAILED DESCRIPTION OF THE EMBODIMENTS

A core of the present application is to provide a coupling system of biomass gasification and waste incineration, which can reduce the amount of activated carbon additionally supplied to a waste incineration assembly, and for which it is unnecessary to separately collect and store the activated carbon generated by a circulating fluidized bed gasifier.

In order to enable those skilled in the art to better understand technical solutions of the present application, the coupling system of biomass gasification and waste incineration according to the present application is further described in detail in conjunction with drawings and specific embodiments.

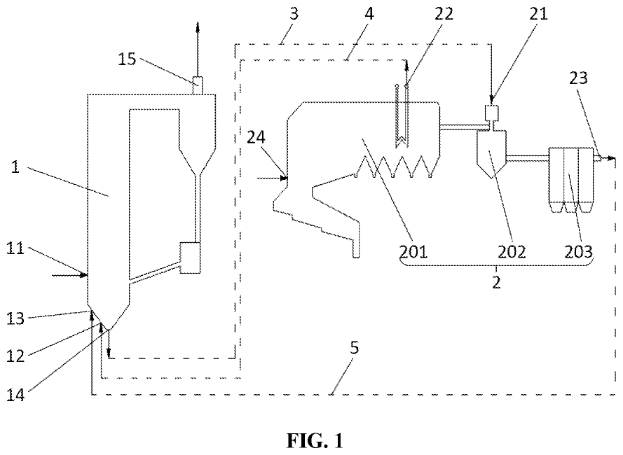

With reference to FIG. 1, a coupling system of biomass gasification and waste incineration is provided according to the present application, including a circulating fluidized bed gasifier 1 and a waste incineration assembly 2. One of products generated by the circulating fluidized bed gasifier 1 is carbon which can be used as activated carbon for the waste incineration assembly 2. A carbon pipeline 3 is communicated between a biomass carbon outlet 14 of the circulating fluidized bed gasifier 1 and an activated carbon injection port 21 of the waste incineration assembly 2, where the activated carbon generated by the reaction in the circulating fluidized bed gasifier 1 is sent to the activated carbon injection port 21 through the carbon pipeline 3, and the activated carbon entering the waste incineration assembly 2 is used to capture harmful substances containing heavy metals and dioxins in flue gas generated by the waste incineration assembly 2.

The circulating fluidized bed gasifier 1 is configured to enable the reaction of the biomass materials in it. The circulating fluidized bed gasifier 1 is provided with a biomass inlet 11, a steam inlet 12, a flue gas inlet 13, a biomass carbon outlet 14 and a biomass gas outlet 15. The waste incineration assembly 2 is configured to enable the reaction of waste materials. The waste incineration assembly 2 includes three modules: a waste incinerator 201, an activated carbon reaction tower 202 and a flue gas dust remover 203, and is provided with an activated carbon injection port 21, a steam outlet 22, a flue gas outlet 23 and a waste feeding port 24. The waste incinerator 201, the activated carbon reaction tower 202 and the flue gas dust remover 203 are communicated in a listed sequence, and the waste gas generated by the waste incinerator 201 passes through the activated carbon reaction tower 202 and the flue gas dust remover 203 in turn. The activated carbon injection port 21 is arranged in the activated carbon reaction tower 202, the flue gas outlet 23 is arranged in the flue gas dust remover 203, and the steam outlet 22 and the waste feeding port 24 are arranged in the waste incinerator 201.

According to the present application, the activated carbon generated by the circulating fluidized bed gasifier 1 is supplied to the waste incineration assembly 2. The circulating fluidized bed gasifier 1 and the waste incineration assembly 2 are coupled with each other, so that the activated carbon generated by the reaction in the circulating fluidized bed gasifier 1 is supplied to the waste incineration assembly 2. Therefore, the amount of the activated carbon additionally supplied to the waste incineration assembly 2 is reduced. It is also possible that no additional activated carbon or a small amount of activated carbon is required to be added into the waste incineration assembly 2. Further, it is unnecessary to separately collect and store the activated carbon generated by the circulating fluidized bed gasifier, which can effectively reduce the operating cost.

On the basis of the above solution, a steam pipeline 4 is communicated between the steam outlet 22 of the waste incineration assembly 2 and the steam inlet 12 of the circulating fluidized bed gasifier 1. Steam is generated while the waste material is burned in the waste incineration assembly 2, and the steam generated by the reaction in the waste incineration assembly 2 enters the steam inlet 12 through the steam pipeline 4, so that biomass materials and the steam undergo gasification reaction in the circulating fluidized bed gasifier 1. In particular, a combustion process takes place in the waste incinerator 201, and the waste material burned in the waste incinerator 201 generates steam, solid refuse, flue gas, harmful substances and the like. The solid refuse can be discharged from below the waste incinerator 201, the steam is discharged from the steam outlet 22, and the steam pipeline 4 leads to the steam inlet 12. The steam generated by the waste incineration assembly 2 is supplied to the circulating fluidized bed gasifier 1 for using and participates in the reaction inside the circulating fluidized bed gasifier 1. The steam is one of the reactants in the circulating fluidized bed gasifier 1. Since the circulating fluidized bed gasifier 1 uses the steam generated by the waste incineration assembly 2 as one of the reactants, the amount of the steam provided from outside can be reduced, and the steam generated by the waste incineration assembly 2 can be fully exploited, so that the steam can be used quickly and effectively.

Furthermore, a flue gas pipeline 5 is communicated between the flue gas outlet 23 of the waste incineration assembly 2 and the flue gas inlet 13 of the circulating fluidized bed gasifier 1, and the flue gas outlet 23 is arranged on the flue gas dust remover 203. The flue gas containing harmful substances generated by the waste incinerator 201 first passes through the activated carbon reaction tower 202 to remove the harmful substances by absorption, then passes through the flue gas dust remover 203 to remove the flue gas dust, and then is introduced into the circulating fluidized bed gasifier 1. The flue gas generated by the reaction in the waste incineration assembly 2 can enter the flue gas inlet 13 through the flue gas pipeline 5, so as to provide the heat required by the gasification reaction by means of the high-temperature flue gas. The flue gas with the harmful substances and dust being removed enters the flue gas inlet 13 through the flue gas pipeline 5. The flue gas does not participate in the material reaction inside the circulating fluidized bed gasifier 1, but provides the heat carried by itself for the circulating fluidized bed gasifier 1, that is, the flue gas provides heat required by the reaction inside the circulating fluidized bed gasifier 1.

According to the above structure, the activated carbon generated by the circulating fluidized bed gasifier 1 is sent to the waste incineration assembly 2 for use, and the steam and flue gas generated by the waste incineration assembly 2 are used by the circulating fluidized bed gasifier 1. The circulating fluidized bed gasifier 1 and the waste incineration assembly 2 are coupled with each other, where the products of reaction from one module are used in the other, and the two work in coordination with each other.

In particular, pneumatic conveying devices are respectively arranged in the carbon pipeline 3 and the flue gas pipeline 5, and the substances in the carbon pipeline 3 and the flue gas pipeline 5 are guided by the pneumatic conveying devices, so that a flowing power is formed for the activated carbon and the flue gas.

Preferably, temperature of the circulating fluidized bed gasifier 1 in the present application is controlled to be between 500° C. and 800° C.

On the basis of any of the above technical solutions and any combination thereof, an explosion-proof isolation device is arranged between the circulating fluidized bed gasifier 1 and the waste incineration assembly 2 according to the present application. Since one of the products generated by circulating fluidized bed gasifier 1 is combustible gas, and the temperature of the waste incineration assembly 2 is relatively high, it is necessary to arranged the explosion-proof isolation device between the circulating fluidized bed gasifier 1 and the waste incineration assembly 2 to prevent the combustible gas from being affected by the high temperature, so as to ensure the safety of the combustible gas.

A leakage detector is arranged near the biomass gas outlet 15 of the circulating fluidized bed gasifier 1 to issue an alarm immediately once a leakage occurs, so as to ensure safe production.

Biomass materials used in the circulating fluidized bed gasifier 1 include rice husks, straws and forestry waste. A specific embodiment of the coupling system of biomass gasification and waste incineration according to the present application is given below. The biomass material enters the circulating fluidized bed gasifier 1 through the biomass inlet 11 and reacts with the steam entering through the steam inlet 12 for gasification, where the high-temperature flue gas entering through the flue gas inlet 13 provides heat required for the gasification reaction. The biomass gas generated after the gasification reaction is discharged through the biomass gas outlet 15 for combustion to generate electricity or for direct use. The biomass carbon generated after the gasification reaction is discharged through the biomass carbon outlet 14 and injected into the activated carbon reaction tower 202 through the activated carbon injection port 21, so as to capture harmful substances such as heavy metals and dioxins in the flue gas. The flue gas in which the harmful substances such as heavy metals and dioxins have been captured is collected by the flue gas dust remover 203.

The biomass material in this embodiment involves rice husks, straws and forestry waste, and their industrial analysis and elemental analysis are as follows.

TABLE 1
Industrial analysis and elemental analysis of raw materials

| | | | | | Indus- |
|---|---|---|---|---|---|
| | | Rice | Forestry | | trial |
| Item | Unit | husks | waste | Straws | waste |
| Total moisture | % | 10.5 | 22.6 | 16.7 | 49.09 |
| Ash As-received Basis | % | 9.71 | 16.27 | 12.02 | 27.97 |
| Volatile Matter As-received | % | 14.87 | 18.02 | 15.35 | 19.83 |
| Basis | | | | | |
| Fixed Carbon As-received | % | 58.19 | 46.66 | 51.09 | 3.11 |
| Basis | | | | | |
| Higher Heat Value As- | MJ/ | 37.27 | 31.07 | 34.98 | 39.33 |
| received Basis | kg | | | | |
| Lower Heat Value As- | MJ/ | 4.09 | 3.19 | 3.41 | 4.05 |
| received Basis | kg | | | | |
| Total Sulfur Content | % | 0.30 | 0.72 | 0.60 | 0.35 |
| Carbon Content As-received | % | 32.94 | 24.36 | 28.90 | 55.62 |
| Basis | | | | | |
| Hydrogen Content As- | % | 0.03 | 0.04 | 0.06 | 7.98 |
| received Basis | | | | | |
| Nitrogen Content As-received | % | 14.76 | 11.89 | 13.49 | 1.70 |
| Basis | | | | | |
| Oxygen Content As-received | % | 13.68 | 10.71 | 12.40 | 34.39 |
| Basis | | | | | |

Three specific working conditions are provided as follows.

Working condition 1: 100% rice husk is burnt in the circulating fluidized bed gasifier. Under 100% load, consumption of the biomass material is 7.26 t/h, flow rate of the biomass gas generated after gasification is 12,857 m3/h, temperature of the biomass gas is 702.4° C., lower heat value of wet biomass gas is 3.349 MJ/m3, gas production rate is 1.771 m3/kg, and carbon production rate is 0.242 kg/kg. The consumption of waste is 70 t/day, and injection amount of the biomass carbon is about 2.91 kg/h.

Working condition 2: 50% rice husk plus 50% forestry waste is burnt in the circulating fluidized bed gasifier. Under 100% load, consumption of the biomass material is 8.48 t/h, flow rate of the biomass gas is 17,304 m3/h, temperature of the biomass gas is 698.4° C., lower heat value of wet biomass gas is 3.128 MJ/m3, gas production rate is 1.546 m3/kg, and carbon production rate is 0.271 kg/kg. The consumption of waste is 70 t/day, and injection amount of the biomass carbon is about 2.91 kg/h.

Working condition 3: 100% straw is burnt in the circulating fluidized bed gasifier. Under 100% load, consumption of the biomass material is 8.54 t/h, flow rate of the biomass gas generated after gasification is 18,267 m3/h, temperature of the biomass gas is 688.4° C., lower heat value of wet biomass gas is 2.926 MJ/m3, gas production rate is 1.685 m3/kg, and carbon production rate is 0.312 kg/kg. The consumption of waste is 70 t/day, and injection amount of the biomass carbon is about 2.91 kg/h.

According to the above description of the disclosed embodiments, those skilled in the art can implement or practice the present application. Many modifications to these embodiments are apparent to those skilled in the art. The general principles defined herein may be applied to other embodiments without departing from the spirit or scope of the present application. Therefore, the present application should not be limited to the embodiments disclosed herein, but should conform to the widest scope in accordance with the principles and the novel features disclosed herein.

1. A coupling system of biomass gasification and waste incineration, comprising a circulating fluidized bed gasifier and a waste incineration assembly;
wherein a carbon pipeline is communicated between a biomass carbon outlet of the circulating fluidized bed gasifier and an activated carbon injection port of the waste incineration assembly;
wherein activated carbon generated by reaction in the circulating fluidized bed gasifier is sent to the activated carbon injection port through the carbon pipeline to capture harmful substances containing heavy metals and dioxins in flue gas generated by the waste incineration assembly.

2. The coupling system of biomass gasification and waste incineration according to claim 1, wherein a steam pipeline is communicated between a steam outlet of the waste incineration assembly and a steam inlet of the circulating fluidized bed gasifier; and
steam generated by reaction in the waste incineration assembly enters the steam inlet through the steam pipeline, so that biomass materials and the steam undergo gasification reaction in the circulating fluidized bed gasifier.

3. The coupling system of biomass gasification and waste incineration according to claim 1, wherein a flue gas pipeline is communicated between a flue gas outlet of the waste incineration assembly and a flue gas inlet of the circulating fluidized bed gasifier; and
flue gas generated by reaction in the waste incineration assembly enters the flue gas inlet through the flue gas pipeline, so as to provide heat required by the gasification reaction by means of high-temperature flue gas.

4. The coupling system of biomass gasification and waste incineration according to claim 3, wherein the carbon pipeline and the flue gas pipeline are respectively provided with pneumatic conveying devices.

5. The coupling system of biomass gasification and waste incineration according to claim 1, wherein temperature of the circulating fluidized bed gasifier is controlled to be between 500° C. and 800° C.

6. The coupling system of biomass gasification and waste incineration according to claim 1, wherein an explosion-proof isolation device is arranged between the circulating fluidized bed gasifier and the waste incineration assembly.

7. The coupling system of biomass gasification and waste incineration according to claim 6, wherein a leakage detector is arranged near a biomass gas outlet of the circulating fluidized bed gasifier.

8. The coupling system of biomass gasification and waste incineration according to claim 1, wherein biomass materials used in the circulating fluidized bed gasifier comprise rice husks, straws and forestry waste.

9. The coupling system of biomass gasification and waste incineration according to claim 2, wherein an explosion-proof isolation device is arranged between the circulating fluidized bed gasifier and the waste incineration assembly.

10. The coupling system of biomass gasification and waste incineration according to claim 3, wherein an explosion-proof isolation device is arranged between the circulating fluidized bed gasifier and the waste incineration assembly.

11. The coupling system of biomass gasification and waste incineration according to claim 4, wherein an explosion-proof isolation device is arranged between the circulating fluidized bed gasifier and the waste incineration assembly.

12. The coupling system of biomass gasification and waste incineration according to claim 5, wherein an explosion-proof isolation device is arranged between the circulating fluidized bed gasifier and the waste incineration assembly.
